(19) United States
(12) Patent Application Publication
(10) Pub. No.: US 2006/0283399 A1
(43) Pub. Date: Dec. 21, 2006

(54) Continuously height-adjustable jump cup attachment bracket and safety feature mechanism

(76) Inventor: Alain Bolduc, Rosemere (CA)

Correspondence Address: Franz BONSANG;c/o PROTECTIONS EQUINOX INT'L INC., Suite 224, 4480, Cote-de-Liesse, Montreal, H4N 2R1, CA

(21) Appl. No.: 11/454,895

(22) Filed: Jun. 19, 2006

Related U.S. Application Data
(60) Provisional application No. 60/691,294, filed on Jun. 17, 2005.

(51) Int. Cl. A01K 15/02

(52) U.S. Cl. 119/705

(57) ABSTRACT

A continuously height-adjustable jump cup attachment bracket for a sporting fence to support a rail includes a jump cup carried on a bearing plate that frictionally engages a support post provided with a channel and a clamping means associated with the bearing plate. The clamping means may be selectively engaged to set the height of the rail of the fence and also to be displaced from such setting in the event of accidental downward movement of the rail in relation to the post.

### CROSS REFERENCE TO RELATED APPLICATIONS

Benefit of U.S. Provisional Application for Patent Ser. No. 60/691,294, filed on Jun. 17, 2005, is hereby claimed.

### FIELD OF THE INVENTION

The present invention relates in general to easily adjustable attaching devices, and more specifically to a continuously adjustable mechanism further comprising a safety feature mechanism for use on a show jumping obstacle, e.g. a fence.

### BACKGROUND OF THE INVENTION

In the field of equestrian show jumping jump cups for supporting poles or rails are required, and the show jumping course builder must first prepare the arena by building obstacles or fences arranged in a predetermined pattern and height. The fences include wing pieces having uprights or posts to which the cups are releasably attached and the fences are installed on what can often be uneven terrain, thus complicating the course building process. Even when only two posts are used for one fence, it is not always easy to ensure that they are level, thereby necessitating time-consuming height adjustments. As one skilled in the art will appreciate, these adjustments are made to ensure that the attachment system or bracket for the jump cups are at substantially the same level in order to put the rail, into a generally horizontal position.

The course builder will set the rails at the appropriate height for the competition and this setting operation is repeated many times through proceedings due to the change in height necessary, or due to a knock-down or disturbance of the fence caused by the horse and rider.

Most apparatus in the art further provides attachment brackets for jump cups that are secured in holes at different predetermined heights, such as at an interval of every six (6) inches for example, thereby limiting the scope for vertical adjustments. When a bracket is repositioned, the speed and easiness at which such an operation is done is of considerable importance, especially considering the number of times this simple operation has to be repeated during a competition.

Another aspect to consider for the safety and security of the horse and rider is the consequences when a rail is knocked down. Various situations may arise in practice, each with different results. A rail most generally falls easily as long as it is pushed in the direction of horse motion rather than in a generally downwardly vertical force, just by being knocked out of the jump cup. In the event however where the force is generally vertically downwards, as if the horse literally “falls” on the fence, the rail stays wedged on the jump cups and then, if the brackets holding the jump cups to the vertical posts are not designed for such a circumstance, injuries can be sustained to the horse and/or the rider. Some releasing systems have been developed in the art but offer different mechanisms.

Many attachment systems for jump cups or the like have been proposed such as those disclosed in the following documents:
U.S. Pat. No. 4,157,180 granted to Favre on Jun. 5, 1979 for an “Adjustable Support for a High Jump Bar”;
U.S. Pat. No. 4,368,875 granted to Weiss on Jan. 18, 1983 for a “Fence Support Structure, Especially for Equestrian Show Jumping”;
European Patent Application Publication No. 408,829 submitted by Bramsiepe and published on Jan. 23, 1991 for an “Equestrian Jumping Stand”;
PCT Patent Application Publication No. 93/24197 submitted by Sebilleau and published on Dec. 9, 1993 for a “Jumping Hurdle with Continuously Height-Adjustable Bar”;
PCT Patent Application Publication No. 99/30791 submitted by Luber and published on Jun. 24, 1999 for a “Device for Releasing Jump Bar Rests”; and
U.S. Pat. No. 6,263,835 granted to Santi on Jul. 24, 2001 for an “Apparatus for Training Horses”.

All the above lack the simplicity of an easily, reliable, safe and quickly height adjustable bracket for jump cups. Some fasteners or attachments are not easily and manually installed and repositioned, are not safe if a horse falls heavily on the horizontal bar in a generally downwardly vertical orientation, and are not continuously vertically adjustable.

Accordingly, there is a need for an improved jump cup attachment bracket.

### SUMMARY OF THE INVENTION

It is therefore a general object of the present invention to provide an improved jump cup attachment bracket.

An advantage of the present invention is that the jump cup attachment bracket is simple, ergonomic, inexpensive, lightweight, easy to operate manually and quickly continuously height-adjustable on a vertical post comprising a channel, thereby saving time in preparing and re-setting the obstacle and also in giving greater flexibility in the height adjustments of jumping sports.

An advantage of the present invention is that the jump cup attachment bracket provides for a safety feature mechanism and is safe if a horse and/ or rider falls in a generally downwardly vertical direction onto the rail supported by the jump cup, by providing a downward sliding action subsequent to an adjustable predetermined force, thereby avoiding injuries.

Another advantage of the present invention is that the jump cup attachment bracket often remains in the channel of the vertical post or in close proximity when displaced following a knockdown or disturbance, thereby saving time in resetting the fence.

Another advantage of the present invention is that the jump cup attachment bracket does not require two adjacent vertical posts to be precisely aligned one with the other, thereby saving installation time.

Still another advantage of the present invention is that the jump cup attachment bracket is made of a solid and shock-resistant material, which furthermore does not deteriorate rapidly with time and weather conditions.

Still another advantage of the present invention is that the jump cup attachment bracket and the associated post are cost effective and easy to manufacture.

According to a first aspect of the invention there is provided in combination a jump cup attachment bracket and a post associated therewith wherein the post defines a guideway for the bracket, the bracket comprising a bearing plate arranged to bear on one side of the guideway frictionally to engage same and adapted to carry a jump cup and further comprising resiliently biased releasable clamping means operable upon another side of the guideway and actuable to locate the bracket at any desired position along the guideway.

The guideway is conveniently in the form of a channel or slot extending along the length of the post which in use is to be disposed vertically or substantially vertically as part of, for example, a show jumping fence. The bearing plate of the bracket may preferably carry the show jump cup as an integral element thereof or may be separately attached thereto. Abutments in the form of blocks may advantageously be arranged on the bearing plate for the purpose of positively locating the plate on the guideway.

The resiliently biased releasable clamping means comprise a rotatable elongate member extending through the bearing plate and having an operating handle at one end on the same side as the jump cup and a stop at the other end thereof. A resilient bias, which may be in the form of an open-coil compression spring, is disposed between the stop and a clamping cam that is rigid with the elongate member, which may be in the form of a rod, the cam being arranged on the opposite side of the guideway with the rod protruding through the guideway. The rod preferably has a handle for facilitating rotation of the rod. The stop is typically a nut, preferably a wing nut, screwably mounted on the threaded other end of the rod. A further stop may be provided intermediate the handle and the clamping cam to distance the latter from the handle to ensure ease of operation.

The invention also relates to a show jumping or other sporting fence including in practice two posts, at least one rail extending between the said posts and supported by a jump cup attachment bracket in accordance with the first aspect of the present invention.

The invention further concerns the jump cup attachment bracket per se.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a top perspective view of a jump cup attachment bracket in accordance with an embodiment of the present invention, one with each vertical post, also with an horizontal bar and in dotted lines a horse and rider;

FIG. 2 is an enlarged top perspective view of the embodiment of FIG. 1, showing the safety feature mechanism;

FIG. 3 is an enlarged top perspective view of the embodiment of FIG. 1;

FIG. 4 is a back perspective view of the embodiment of FIG. 1 with sections taken out of the vertical post;

FIG. 5 is a back perspective view of the embodiment of FIG. 1 showing the insertion of the attachment bracket into the channel of the vertical post;

FIG. 6 is a back perspective view of the embodiment of FIG. 1 showing the continuous generally vertical height-adjustment within the post;

FIG. 7 is a back perspective view of the embodiment of FIG. 1 showing the initial tightening on the post; and

FIG. 8 is a back perspective view of the embodiment of FIG. 1 showing the final tightening on the post.

### DETAILED DESCRIPTION OF THE PREFERRED EMBODIMENTS

With reference to the annexed drawings the preferred embodiments of the present invention will be herein described for indicative purpose and by no means as of limitation.

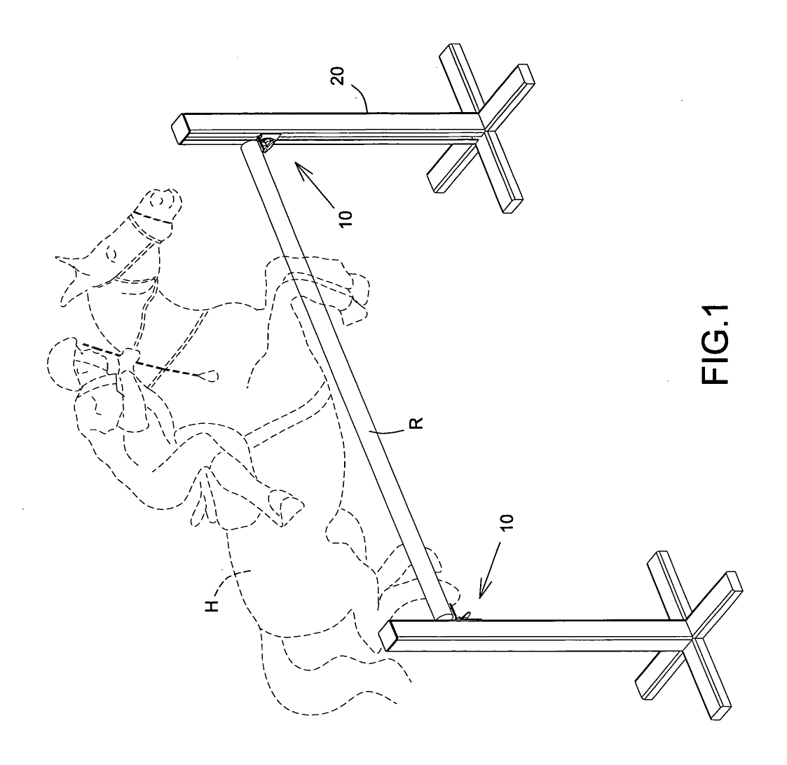

FIG. 1 shows a jump cup attachment bracket device 10 used in conjunction with each vertical post 20 in a jumping competition. More than one device per post 20 can also be used such as in a triple bar contest. A horse H and its rider are shown in dotted lines jumping a fence, represented by a generally horizontal rail R in this equestrian example. Each end of the rail R rests on a respective device 10 to provide the necessary stability.

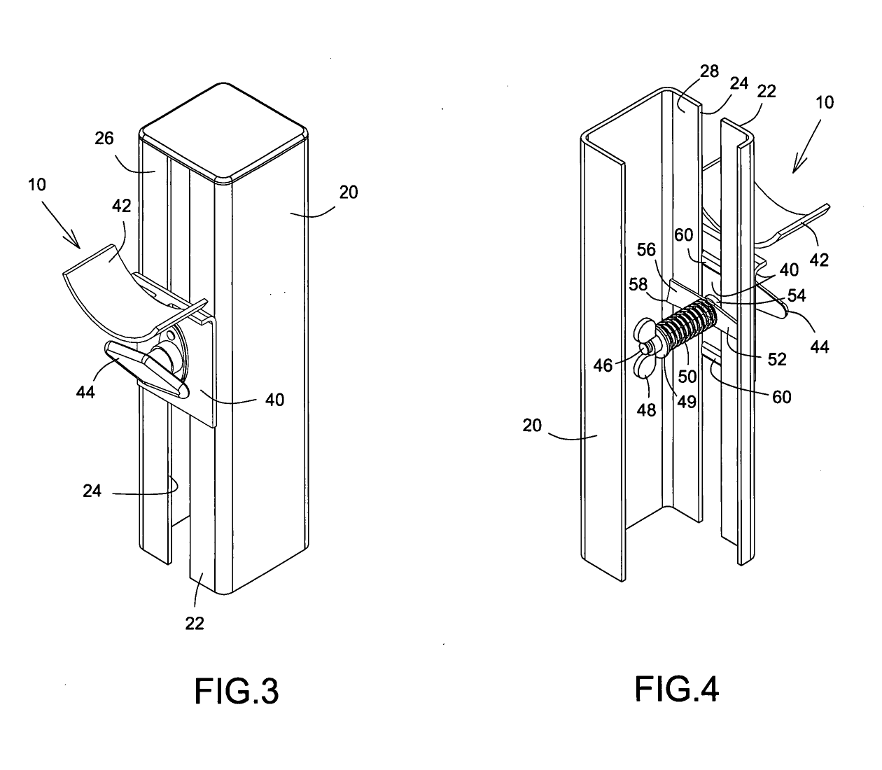

As more clearly seen in FIG. 3, each device 10 comprises a generally vertical plate 40. A standard cup 42 of generally concave form is secured on the plate 40 to receive the rail R end (as seen in FIG. 1). A handle 44 is rotatably mounted in the plate 40. The post 20 is preferably hollow with at least one preferably flat surface 22. The flat surface 22 comprises a channel 24 extending longitudinally and continuously most of the height or length of post 20. The flat surface 22 of the post 20 comprises a first face 26 and a second face 28. Preferably, the plate 40, cup 42 and handle 44 are on one side, such as on the first face 26, of the flat surface 22 of the post 20. It will be easily understood also that the two devices 10 used in conjunction to support a rail R are facing each other so as to have the two cups 42 opposing one another, and not having any of the vertical posts 20 intervening therebetween.

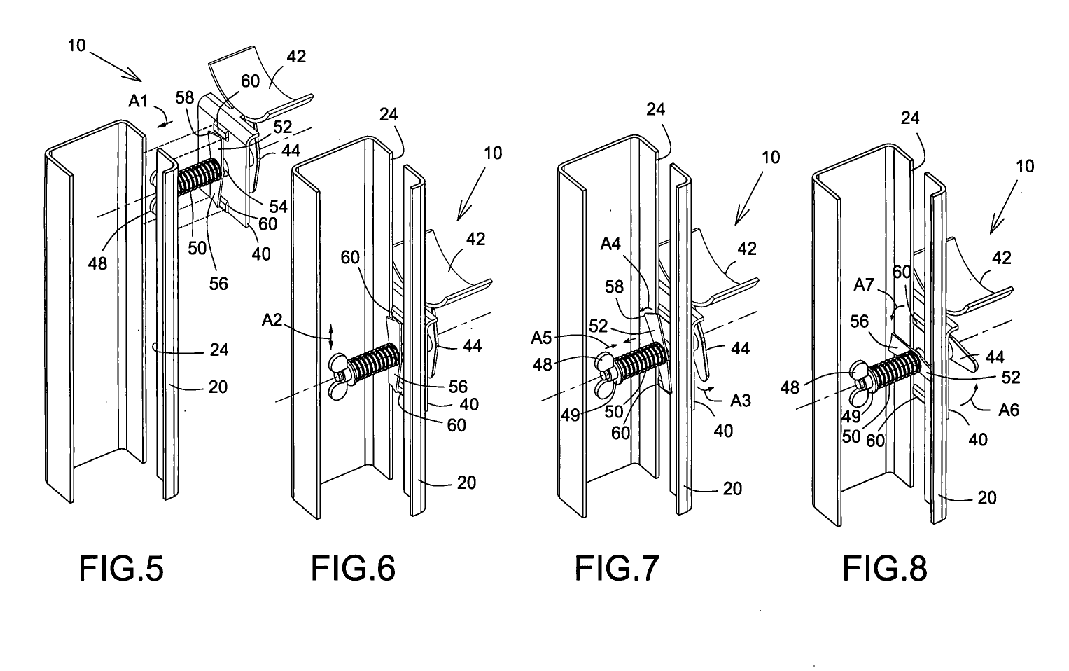

As more clearly seen in FIGS. 4 and/or 5, a generally horizontal rod 46 goes through an aperture (not shown) in the plate 40 and is secured to the handle 44. A stopper 48 is positioned at one extremity of the rod 46 opposite the handle 44 and restrains a coil spring 50 or other resilient mechanism. The spring 50 covers the rod 46 and extends from the stopper 48 to a wing cam member 52. Typically, the stopper 48 is a conventional nut, or wing nut (for direct operation thereof without specific hand tool), screwably mounted on a threaded end of the rod 46, with a conventional washer 49. The wing cam member 52 is prevented from coming into contact with or being pushed towards the plate 40 by an abutment 54 in the rod 46 in close proximity with the plate 40. The sides or wings 56 of the cam 52 have a slightly curved shape wherein the initial rotating edges 58 are slightly bent away from the plate 40 to engage more easily the channel 24 of the post 20, as will be explained in more detail below. Abutments 60 of the width corresponding to the width of the channel 24 are secured on the plate 40 on the side of the cam 52, as shown with the dotted lines of FIG. 5. The device 10 is inserted within the channel 24 of the post 20 by following the direction indicated by arrow A1. It should be noted that the lateral dimension of the post 20 is preferably greater than the length of the rod 46, and that the device is manufactured in such a way that the sides 56 of the cam 52 of the device 10 do not obstruct the insertion prior to being secured to the post 20, i.e. prior to the handle 44 of the device 10 being turned.

As indicated in the FIG. 6, when the back of the plate 40 rests on the first face 26 of the flat surface 22 of the post 20, and the abutments 60 snugly fit in the channel 24, the device is free to continuously move up or down as indicated by the arrow A2. This provides an infinite amount of vertical positions for the device 10 along the post 20. As one skilled in the art will understand this is extremely useful since the arena where the two adjacent posts 20 of the fence shown in FIG. 1 are located is not generally horizontally level.

As indicated in the FIG. 7, to secure the device 10, the handle 44 is then rotated, as shown with arrow A3. The abutments 60 prevent the plate 40 of the device 10 to simultaneously rotate. The cam 52 is therefore forced to rotate following arrow A4. This is where the bent of the initial rotating edges 58 becomes useful in such a way that said edges 58 of the sides 56 engage the channel 24 of the post 20 more easily. This rotational movement of the cam 52 forces a slight longitudinal displacement of the spring 50. Since the stopper 48 prevents the spring 50 to move at one end, a compressing action, which can be varied by changing the position of the wing nut 48 along the rod 46, is applied to the spring 50 as indicated by arrow A5. A corresponding tightening and clamping action starts to maintain the device 10 in place. Of course, the given stiffness, elasticity or compressive constant of the spring 50 affects how easy it becomes to set up the device 10 on the post 20.

Alternatively, the stopper 48 could be located at a fixed location on the rod 46 to ensure a predetermined known stiffness, elasticity or compressive constant of the coil spring 50.

As indicated in the FIG. 8, further rotation of the handle 44 as indicated by arrow A6 causes further movement on the cam 52 as indicated by arrow A7 and a better tightening of the device 10 at the desired height position on the post 20.

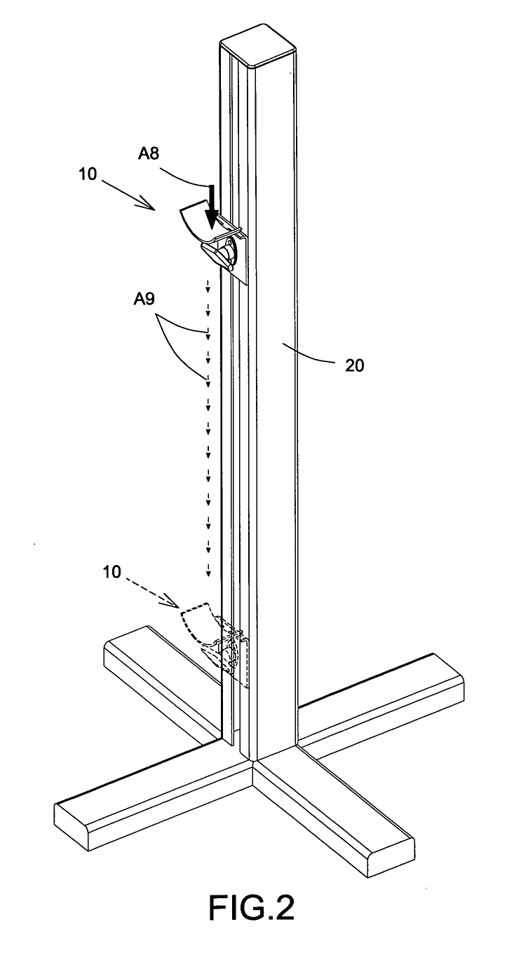

In some circumstances, a horse H or a rider may fall on the rail R and provide a strong and sudden generally downwardly vertical force, as represented in FIG. 2 by the arrow A8. Usually, the cup 42 is configured so as to let the rail R go relatively easily, especially on the side of the cup 42, but one will understand that the wind for example should not cause the rail R to fall, thereby the need for the concave cup 42. When the force of a horse H falling does not bring the rail R down on the sides of the cup 42 and instead pushes down vertically on the cup 42, the appropriate and chosen stiffness, elasticity or compressive constant of the spring 50 permits the device 10 to descend if subjected to a predetermined initial force. For instance, an initial force of about thirty pounds (30 lbf or 135 Newtons) could override the resisting force keeping the device 10 in place and push said device 10 downwardly. Once the initial force is overridden, a lower friction force of for example twenty pounds (20 lbs) would need to be superseded to continue to push the device 10 downwardly, as represented by arrows A9. In such unfortunate circumstances, a horse H or rider would see their fall not obstructed by any mechanical obstacle since the device 10 can slide down until said horse H would be in close proximity to the ground and therefore avoid potentially damaging injuries. In the situation where more than one device 10 is used per post 20, the same principle applies with the exception that the cumulating friction force of the two devices 10 would have to be taken into account to determine the forces to overcome and the constants to be used by each spring 50.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

I claim:

1. A combination of a jump cup attachment bracket and a post associated therewith wherein the post defines a guideway for the bracket, the bracket comprising a bearing plate arranged to bear on one side of the guideway frictionally to engage same and adapted to carry a jump cup and further comprising resiliently biased releasable clamping means operable upon another side of the guideway and actuable to locate the bracket at any desired position along the guideway.

2. A combination according to claim 1 wherein the guideway is in the form of a channel extending longitudinally of the post.

3. A combination according to claim 1 wherein the jump cup is formed integrally with the bearing plate.

4. A combination according to claim 2 wherein the bearing plate is provided with abutments for locating the plate on the guideway.

5. A combination according to claim 1 wherein the resiliently biased releasable clamping means comprise a rotatable elongate member extending through the bearing plate and having an operating handle at one end on the same side as the jump cup and a stop at the other end thereof.

6. A combination according to claim 5 wherein a clamping cam is secured to the elongate member, and the resilient bias is an open coil compression spring disposed between the stop and the clamping cam.

7. A combination according to claim 6 wherein the elongate member is in the form of a rod.

8. A combination according to claim 7 wherein the stop is a nut screwably mounted on the threaded other end of the rod.

9. A combination according to claim 8 wherein the nut is a wing nut.

10. A combination according to claim 5 wherein a further stop is provided intermediate the handle and the clamping cam.

11. A combination according to claim 6 wherein the clamping cam is winged and the wings are canted away from the bearing plate.

12. A sporting fence including in practice two posts, at least one rail extending between the said posts and supported by a pair of jump cup attachment brackets in accordance with claim 1.

13. A sporting fence according to claim 11 wherein the fence is an equestrian show jumping fence.

14. A jump cup attachment bracket for the combination claimed in claim 1.
